(19) United States
(12) Patent Application Publication
(10) Pub. No.: US 2008/0025040 A1
(43) Pub. Date: Jan. 31, 2008

(54) LED light engine

(76) Inventor: Michael J. Swantner, Saxonburg, PA (US)

Correspondence Address: OSRAM SYLVANIA INC, 100 ENDICOTT STREET, DANVERS, MA, 01923, US

(21) Appl. No.: 11/492,494

(22) Filed: Jul. 25, 2006

(51) Int. Cl. G02B 6/00

(52) U.S. Cl. 362/581; 362/555

(57) ABSTRACT

A light emitting diode (LED) light engine (10) has a longitudinal axis (11) and comprises: a heatsink (12) having a base (14); an LED receiving pocket (16) formed with the base (14); at least one LED (18) mounted in the pocket (16); a light dispenser holder (22) positioned adjacent the pocket (16); and a light dispenser (24) fixed in the light dispenser holder (22) in a light gathering relationship with the at least one LED (18).

### TECHNICAL FIELD

This application relates to light engines and more particularly to solid state light engines. Still more particularly it relates to such light engines for back lighting signs

### BACKGROUND ART

Illuminable signs have employed incandescent, fluorescent and neon light sources to back light or illuminate the sign or other display. Recently, solid-state light sources such as those using light emitting diodes (LED or LED s) have been employed with some success. However, the available solid-state light sources have been complicated structures that have been expensive to manufacture and difficult to use.

### DISCLOSURE OF INVENTION

It is, therefore, an object of the invention to obviate the disadvantages of the prior art.

It is another object of the invention to enhance light engines.

It is yet another object of the invention to enhance the manufacturability of light engines.

These objects are accomplished, in one aspect of the invention, by the provision of a light emitting diode (LED) light engine having a longitudinal axis and comprising a heatsink having a base; an LED receiving pocket formed with the base; at least one LED mounted in the pocket, a light dispenser holder positioned adjacent the pocket; and a light dispenser fixed in the light dispenser holder in a light gathering relationship with at least one LED.

The heatsink and light dispenser holder are preferably formed from a single piece of stamped metal, simplifying construction and reducing cost.

### BRIEF DESCRIPTION OF THE DRAWINGS

FIG. 1 is a perspective view of an embodiment of the invention;

FIG. 2 is an elevational sectional view of the embodiment of FIG. 1; and

FIG. 3 is a plan view of a stamping that can be formed into the heatsink of the invention.

### BEST MODE FOR CARRYING OUT THE INVENTION

For a better understanding of the present invention, together with other and further objects, advantages and capabilities thereof, reference is made to the following disclosure and appended claims taken in conjunction with the above-described drawings.

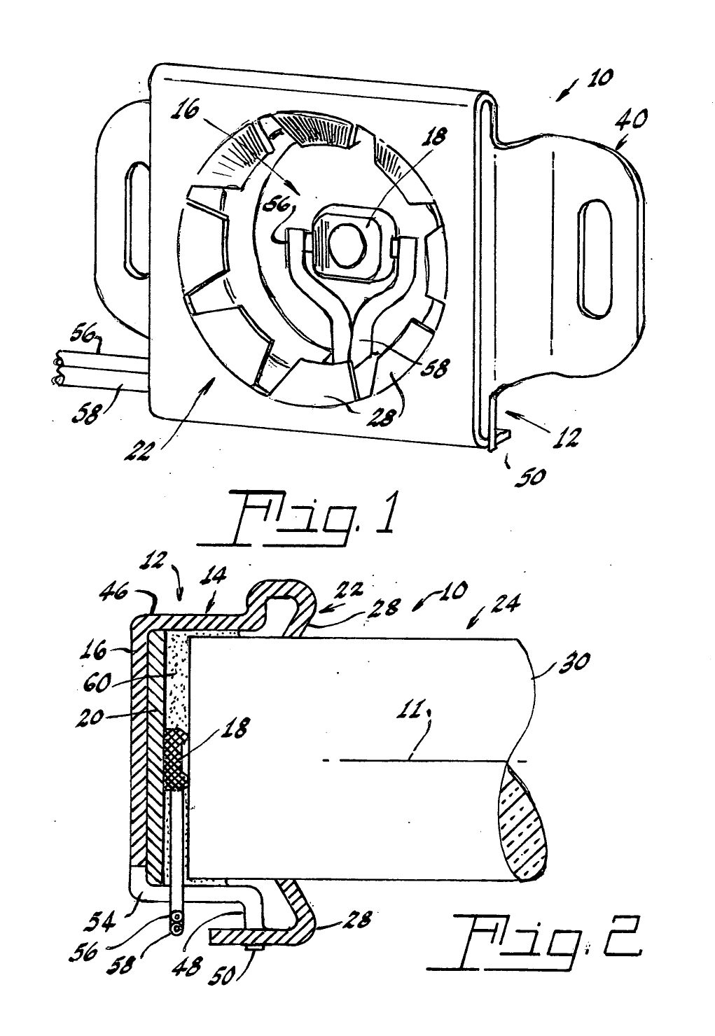

Referring now to the drawings with greater particularity, there is shown in FIG. 1 a light emitting diode (LED) light engine 10 with a longitudinal axis 11 and comprising a heatsink 12 having a base 14. The heatsink 12 is preferably formed of a suitable, thermally conductive material, for example, aluminum or brass, with aluminum being preferred. A pocket 16 is associated with the base 14 and preferably is formed therein, as by stamping or deep drawing. At least one LED 18 mounted in the pocket 16 on a thermal adhesive 20. A light dispenser holder 22 is positioned adjacent the pocket 16; and a light dispenser 24 is fixed in the light dispenser holder 22 in a light gathering relationship with the at least one LED 18.

The light dispenser holder 22 is spaced from the pocket 16 along the longitudinal axis 11 and in a preferred embodiment of the invention is integral therewith. The light dispenser 20 comprises an aperture 22a and a plurality of inwardly extending fingers 22b that grasp, hold and center the light dispenser 24, which preferably comprises an acrylic rod 30.

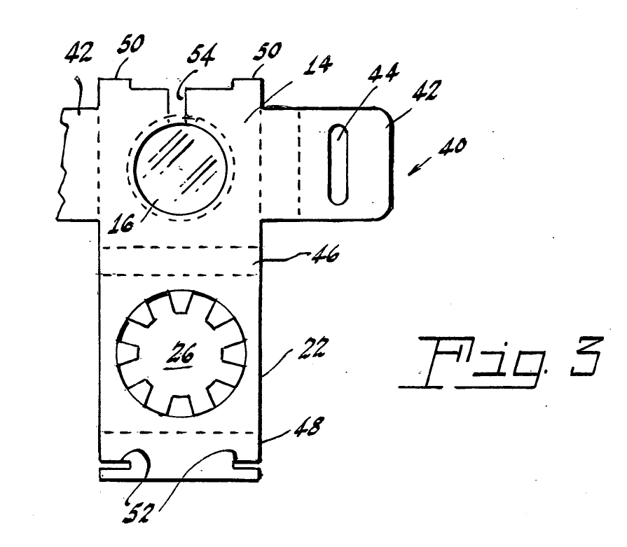

The mounting of the light dispenser 24 can be seen more clearly in FIG. 2.

To prepare the light engine 10 a heatsink blank 40 (FIG. 3) is formed from the desired material, as by stamping. The blank 40 includes the base 14 and oppositely extending mounts 42 that can have elongated mounting apertures 44 formed therein. Only one such mount 42 is completely shown.

A lateral wall 46 connects the base to the light dispenser holder 22 and a second lateral wall 48 projects from the opposite side of the light dispenser holder. Folding the blank 40 on the dashed lines forms the heatsink 12. The heatsink assembly is fixed together by inserting the tabs 50 formed on the base 14 into the slots 52 formed on the second lateral wall 48. A connecting wire slot 54 is also provided in the base 14 and communicates with the pocket 16.

To complete the light engine 10 the thermal adhesive 20 is applied to the back of the pre-wired LED 18 or the bottom of the pocket 16 and the LED 18 is assembled into the heatsink 12 with the wires 56, 58 extending through the connecting wire slot 54. The light dispenser holder 22 is then bent into the position shown in FIG. 2 and the tabs 50 are inserted into the slots 52 to lock the wall together. A clear acrylic potting material 60 is placed in the pocket and the acrylic rod 30 is inserted. The fingers 22b position the rod 30 while the potting material cures. Use of the potting material 60 removes the requirement for the light gathering end of the rod 30 to be polished.

There is thus provided a light engine that is easily fabricated, inexpensive and very rugged.

While there have been shown and described what are at present considered to be the preferred embodiments of the invention, it will be apparent to those skilled in the art that various changes and modifications can be made herein without departing from the scope of the invention as defined by the appended claims.

What is claimed is:

1. A light emitting diode (LED) light engine having a longitudinal axis and comprising:
a heatsink having a base;
an LED receiving pocket formed with said base;
at least one LED mounted in said pocket;
a light dispenser holder positioned adjacent said pocket; and
a light dispenser fixed in said light dispenser holder in a light gathering relationship with said at least one LED.

2. The LED light engine of claim 1 wherein said pocket is formed in said base.

3. The LED light engine of claim 1 wherein said light dispenser holder is spaced from said pocket along said longitudinal axis.

4. The LED light engine of claim 1 wherein said at least one LED is mounted in said pocket via a thermal adhesive.

5. The LED light engine of claim 1 wherein said light dispenser holder comprises an aperture provided with inwardly projecting arms.

6. The LED light engine of claim 1 wherein said light dispenser comprises an acrylic rod.
